(19) United States
(12) Patent Application Publication
(10) Pub. No.: US 2009/0198976 A1
(43) Pub. Date: Aug. 6, 2009

(54) METHOD AND STRUCTURE FOR HIGH-PERFORMANCE MATRIX MULTIPLICATION IN THE PRESENCE OF SEVERAL ARCHITECTURAL OBSTACLES

(76) Inventors: Vernon R. Austel, Cortlandt Manor, NY (US); John A. Gunnels, Yorktown Heights, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/027,110

(22) Filed: Feb. 6, 2008

(51) Int. Cl. G06F 9/30

(52) U.S. Cl. 712/225; 712/E09.016

(57) ABSTRACT

A method (and apparatus) for processing data on a computer having a memory to store the data and a processing unit to execute the processing, the processing unit having a plurality of registers available for an internal working space for a data processing occurring in the processing unit, includes configuring the plurality of registers to include at least two sets of registers. A first set of the at least two sets interfaces with the processing unit for the data processing in a current processing cycle. A second set of the at least two sets is used for removing data from the processing unit of a previous processing cycle to be stored in the memory and preloading data into the processing unit from the memory, to be used for a next processing cycle.

### BACKGROUND OF THE INVENTION

1. Field of the Invention

The present invention generally relates to improving efficiency for matrix multiplication processing on a computer having a floating point unit (FPU) having its own internal registers as a working space for the matrix multiplication processing. Specifically, two smaller sets of FPU registers are allocated for the processing, rather than the conventional, largest-possible, single set of registers, thereby virtually eliminating the end-of-reduction overhead that degrades efficiency when the conventional single-set method is used.

2. Description of the Related Art

FIG. 1 shows exemplarily a schematic diagram 100 of a typical computer having a main memory 101 providing and storing data related to processing in at least one central processing unit (CPU) 102 and at least one floating point unit (FPU) 103, as interconnected by data/address/control busses 104, 105. The CPU 102 and FPU 103, respectively, include a register set 106, 107. It is noted that, although FIG. 1 shows only one CPU/FPU, a computer will often have more than one such CPU/FPU and there is no implication that the present invention is limited to a machine having only one CPU/FPU and no implication that each CPU has a corresponding FPU.

The typical computer architecture 100 will also include one or more levels of cache memory to serve as local, faster memory for both the CPU 102 and FPU 103. FIG. 1 shows three levels of cache, L1-L3 (108-110), with L1 being closest to the CPU/FPUs, but additional cache memory 111 is also possible. The details of cache memory, including various configurations of precise location within the computer hardware, relative to the CPU chip, are well known in the art and not particularly significant for understanding the present invention.

For purpose of the explanation of the present invention, the FPU 103 is assumed to be the processor used for matrix multiplication processing and the FPU registers 107 comprise the working space for the reduction processing.

In one of its aspects, the present invention also involves prefetching. In hardware, “prefetch”, also referred to as “stream I/O”, means reading a block or more in advance of a steadily advancing read/write stream and is roughly twice as fast as random I/O data movement.

In software, prefetching may mean simply fetching operands in advance of their use (e.g., 10's of cycles before needed) and allows for operand-fetch delay from L3 (e.g., level 3 cache) or memory. This prefetching is also sometimes referred to as a “nonblocking load.” In software, prefetching may also mean fetching memory in advance of using it, but not using the fetched data. There are often special instructions for this purpose, such as the Data Cache Touch instruction (e.g., “dcbt”).

This form of prefetching could be used, for example, to ensure that data is in cache when needed later and can be viewed as a form of moving data in the memory hierarchy. In software, prefetches may be added by the compiler or manually (e.g., a programmer adds instructions as steps in a program as opposed to a compiler automatically adding the instructions during compilation).

The present invention is also exemplarily directed to matrix processing, with particular emphasis on matrix multiplication. FIG. 2 diagrammatically shows a matrix multiplication reduction processing 200 wherein operands (e.g. a row block of matrix A data 201 and a column block of matrix B data 202) are processed in an FPU using the multiplication technique of reduction. Assuming data block 201 to be a single row of matrix A data and data block 202 to be a single column of matrix B data, the result 203 is the summation of aibi, where i=0, 1, . . . (n-1), and n is the length of the row and column data. This process of arriving at the summation of row/column-multiplied elements is “reduction”, as used in the present discussion. Thus, at the lowest level, box 203 represents a block of data being processed by the FPUs involving a subset of registers 107 of the FPU 103 shown in FIG. 1.

It is noted that FIG. 1 is described above as if the data blocks 101,102 are size (n×1), but the same concepts apply when the blocks 101,102 have more than one row or column (e.g, blocks of size (4×100) and (100×4)) that are reduced in the FPU in increments of the data block, as demonstrated in FIG. 3, so that matrix multiplication can be viewed ultimately as being reduction processing in the FPU.

Typically, a bit more than half or so of the register set 107 of the FPU 103 is used for the buffer. Also, typically, the rectangles 201 and 202, representing matrix data (e.g., at least a portion of an appropriate row and column of the immediate operands), are as long as possible (e.g., the dimensions might be 100×4 or so, if the matrix is big enough). Data 203 currently being processed is in registers 107 of the FPU 103 and data blocks 201 or 202 will be streaming into the FPU, typically via the L1 cache, from some larger, slower cache (e.g., L3).

Stepping to a larger view in the case in which each block 201,202 of data of FIG. 2 has four rows (columns), FIG. 3 exemplarily shows each matrix multiplication element 304 as resulting from successively processing of one block of data of operand 301 with one block of data of operand 302. Everything (e.g., data blocks 301,302,303) would be in the next largest (and next slower) memory area, presumed in this discussion to be L3. More realistically, for large matrices, matrix A and B are much larger and cannot be completely stored in L1 cache, so that data 301 and 302 have to be streamed into the process that occurs as data passes through L1 cache into the FPU.

Each of the sub operations (the reductions 303, which would be 16 in this case of the larger perspective shown in FIG. 3) would be performed knowing that the rate that can be sustained typically is determined mostly by L3. The designer/programmer decides on the dimensions of these objects 301,302,303, based on the size of L3. There might be a level above this view shown in FIG. 3, in which case the next higher view would appear similar to that exemplarily shown in FIG. 2, but where 203 would now be the buffer in L3 and the operands 201 and 202 would be streaming in from some slower (and larger) memory area, including perhaps from other processors.

Ideally, because of its faster speed and the direct interface between L1 and the FPU registers, one would like to have everything in L1 ahead of time, so the reduction-style of matrix processing can zip through the various sub-operations in the FPU, and the basic view of reduction-style of matrix processing can be considered to be that shown in FIG. 2. The difficulty in using L1 is that the dimensions here are very small. That is, instead of element size being, say, 100×4, they might be something like 8×4.

However, these are rather strange values for someone implementing matrix multiplication from a higher perspective, since matrix multiplication is typically considered to be executed using long operands for the reduction, precisely because that longer length is considered to mitigate the effects of processing shown in FIG. 4, which the present inventors refer to as the “end-of-reduction overhead” as a terminology to describe the processing cost assumed to be inherent in matrix multiplication reduction in the conventional method.

That is, as shown in FIG. 4, in the conventional method of matrix reduction processing, it is assumed that the A and B data blocks 201,202 (reference back to FIG. 2) are streamed into the FPU during a first processing cycle 401 and are processed in the FPU as represented by block 402A that represents the set of registers in the FPU used as a working space for the reduction processing. Since the register set was the working space for the reduction, upon completion of the reduction cycle, data block 402A is now filled with reduced data just processed by the FPU and must be removed for the next processing cycle 401′. As shown in block 402B, the FPU register set must then be loaded with data for the next cycle 401′.

Thus, intermediate period 402 is needed to first extract the data resultant from the previous reduction processing cycle remaining in the FPU register buffer set to write this data to memory, through cache L1 (e.g., during period 402A), and data is then preliminarily read into the buffer through L1 (e.g., during period 402B), after which the streaming of the next two data blocks 201′, 202′ occurs in time period 401′.

This intermediate period 402 represents the “end-of-reduction overhead” addressed by the present invention, that temporarily disrupts the reduction processing in the FPU, as well as the data streaming that occurred during period 401, to be resumed in the next reduction cycle 401′. This disruption can reduce overall efficiency of the matrix multiplication processing to be in typical ranges of 96-97%.

Until the present invention, conventional wisdom ignored this end-of-reduction overhead as inherent in the reduction multiplication processing on standard computer architectures. Conventional wisdom also considered that the largest possible data block size that would fit into the FPU register set should be used as the working set of FPU registers for the matrix multiplication processing, in order to get the greatest amount of data reduced during each reduction processing cycle.

In general, computer implementers use hierarchical decomposition to combine these two strategies (e.g., reductions versus panels) in levels, alternating them through the cache hierarchy, as briefly described above. At the lowest level, however, one always uses reduction in the FPU. The computer architecture must be designed to sustain the I/O rate of the lowest-level kernel and it is no accident that they generally do. In the particular architecture of the BlueGeneL® (e.g., BG/L), this match is good but not perfect. The size of the reduction buffer is limited by the number of registers.

In the BG/L memory hierarchy, there is a relatively small number of registers (e.g., 64), meaning that the maximum N×N buffer size is 6×6=36 for the FPU working register set. It would be theoretically possible to form a 7×7=49 buffer size, but the practical need to have registers for other needs precludes this larger size.

Also, in the BG/L, the L1 (e.g., level 1) cache is also relatively small (e.g., 4 k doubles). In the exchange of data between L1 cache and the FPU register set buffer, the access to L1 has no delay if data is already in L1 (e.g., a “hit”), otherwise, there is a delay that is the same as an access to L3 (e.g., level 3) cache or to memory. There is no limit on I/O rate for the L1 cache.

In the BG/L, the L3 cache is relatively large (e.g., 500 k doubles). Although access to L3 is shorter than access to memory, it is still relatively long (e.g., 30+ cycles). The L3 cache can sustain an I/O rate of 5.3 bytes/cycle (in streaming mode). The main memory of the BG/L has a long delay (e.g., 50 cycles or more) and can sustain an I/O rate of 4 bytes/cycle (in streaming mode).

The problem presented to the present inventors was that of obtaining 100% efficiency on the BG/L for matrix multiplication processing, given its somewhat limiting machine architecture and memory hierarchy, as follows.

A 6×6 buffer in the FPU register set is 100% efficient if data is in the L3. With hierarchical decomposition, the data is usually, but not always, in L3. If the BG/L had an 8×8 buffer, 100% efficiency could be achieved for the multiplication processing, even if the data were in memory, but there would be an end-of-reduction penalty (to be discussed shortly). But at least the reduction itself could proceed at 100% without any delays due to operand fetching.

In more general terms, the present invention addresses achieving high-performance in matrix multiplication with the following potential hardware shortcomings:

1) Limited (low) memory/cache bandwidth. This can have many causes such as low-bandwidth memory, low-bandwidth cache at the first “useful” level, etc.

2) Small FP register set: If the register set is not large enough to allow the application of any known method to avoid the abovementioned bandwidth problem.

3) Limited (low) number of allowed “instructions in flight” (outstanding misses).

Even if the bandwidth is high, if the latency is not extremely low, one may go over the threshold of allowed outstanding misses very quickly. By treating the memory/cache as low-bandwidth that can be avoided.

Traditional techniques deal with the problem of limited bandwidth by blocking, and the conventional wisdom is that larger blocks that will fit into the FPU register set are considered to be better. On some machines, the largest block size requires that operands be fetched at a higher rate than the machine is capable of delivering from the slowest parts of the memory hierarchy.

Thus, during the buffer write/read phase 402 shown in FIG. 4, operand data 201, 202 is no longer streaming at the normal 3 cycles/operand. This end-of-reduction buffer write/read phase 402 is a complete disruption to the normal I/O streaming of operands and can reduce overall efficiency to approximately 96-97%.

Thus, there exists a need to improve efficiency in matrix multiplication processing, given size constraints of cache on a machine used for the processing, such as on the BG/L. More particularly, there is a need to reduce the end-of-reduction overhead on machines using the L1 cache/FPU register interface.

### SUMMARY OF THE INVENTION

In view of the foregoing, and other, exemplary problems, drawbacks, and disadvantages of the conventional systems, it is an exemplary feature of the present invention to provide a structure (and method) in which end-of-reduction overhead is virtually eliminated in the reduction processing of matrix multiplication.

It is another exemplary feature of the present invention to contradict the conventional wisdom of processing matrix multiplication data in the FPU in the largest size possible by, instead, processing matrix data alternately in two smaller register sets.

It is another exemplary feature of the present invention to teach using two smaller FPU register sets, wherein one register set is used for the active processing while the second register set is being subjected to streaming of data to store reduced data of the previous reduction cycle into memory or to stream new matrix data from memory into the register set for use in the next reduction cycle.

It is another exemplary feature of the present invention to improve the efficiency of reduction processing of matrix multiplication at the lowest level of processing at the L1 cache/FPU interface by streaming data through the cache hierarchy as a background operation concurrent with matrix reduction being executed by the FPU.

It is another exemplary aspect of the present invention to demonstrate how operand fetch can be decoupled from movement of data in the memory hierarchy in combination with using two register sets rather than a single large register set, such that operands are prefetched into the cache at a slow rate in advance as a background operation, so that when the operands are needed they can be supplied at a higher rate from the cache.

In a first exemplary aspect of the present invention, to achieve the above features and objects, described herein is an apparatus, including a memory to store data for a data processing and at least one processing unit having a plurality of registers available for an internal working space for a data processing occurring in the processing unit, wherein the plurality of registers are configured to comprise at least two sets of registers. A first set of the at least two sets interfaces with the processing unit for the data processing in a current processing cycle of the processing and a second set of the at least two sets is used for removing data from the processing unit of a previous processing cycle to be stored in the memory and for preloading data into the processing unit from the memory, to be used for a next processing cycle.

In a second exemplary aspect of the present invention, also described herein is a method of processing data on a digital processing apparatus having a memory to store said data and a processing unit to execute the processing, the processing unit having a plurality of registers available for an internal working space for a data processing occurring in the processing unit, including configuring the plurality of registers to comprise at least two sets of registers. A first set of the at least two sets interfaces with the processing unit for the data processing in a current processing cycle of the processing and a second set of the at least two sets is used for removing data from the processing unit of a previous processing cycle to be stored in the memory and preloading data into the processing unit from the memory, to be used for a next processing cycle.

In a third exemplary aspect of the present invention, also described herein is a signal-bearing medium tangibly embodying a program of machine-readable instructions executable by a digital processing apparatus to perform the method described in the previous paragraph.

The present invention provides a method to increase the efficiency of processing data in machines having a processor or coprocessor that uses a set of internal registers as a working space during the data processing such that the processing need not be interrupted due to having completed a processing cycle on a block of data.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 exemplarily shows a typical generic computer architecture 100 having a cache/FPU, using a subset of FPU registers 107 as the working space for the matrix multiplication processing occurring in the FPU;

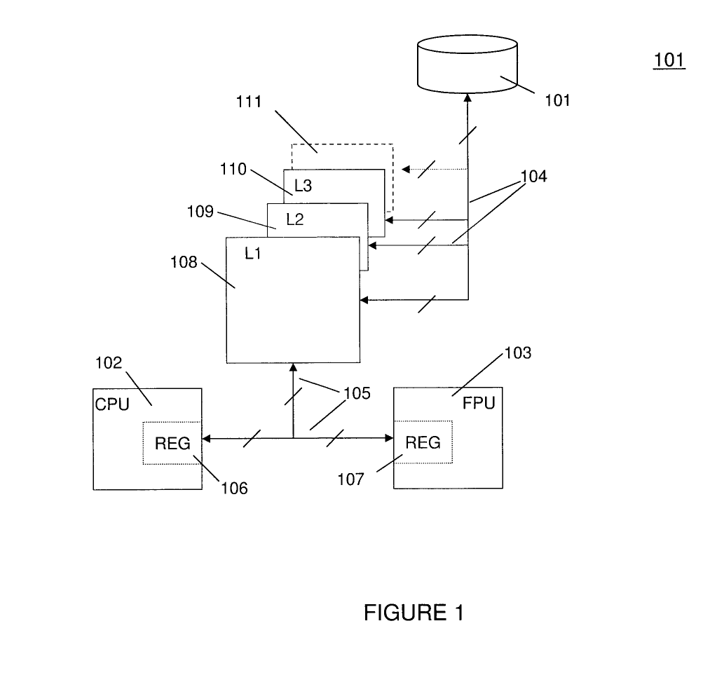

FIG. 2 exemplarily shows matrix multiplication reduction processing 200;

FIG. 3 exemplarily shows a higher level perspective 300 of matrix multiplication that demonstrates that reduction processing is ultimately occurring in the FPU level even when higher levels of cache are used in the streaming process;

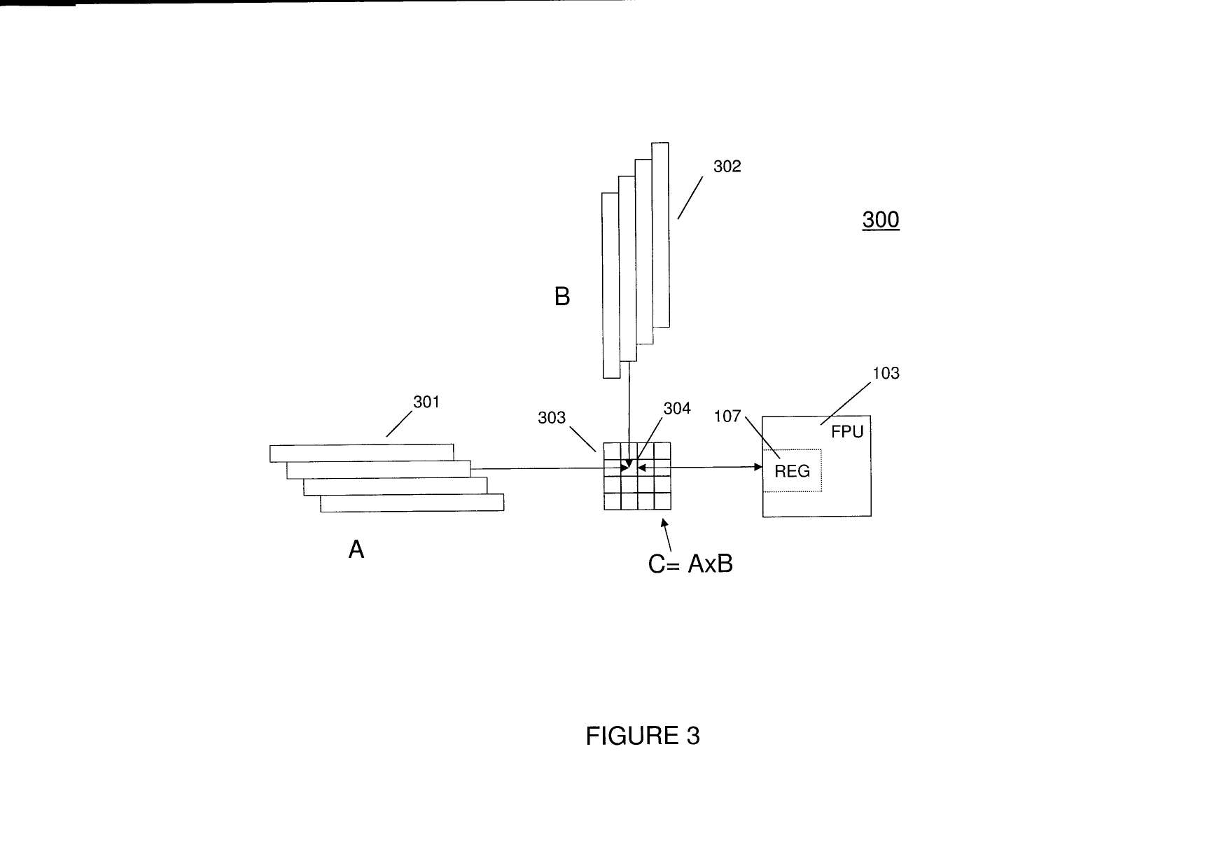

FIG. 4 exemplarily shows end-of-reduction overhead 400;

FIG. 5 illustrates an exemplary flowchart 500 of the method of the present invention;

FIG. 6 shows diagrammatically the concept 600 of using one FPU register set 601 for current reduction processing, while a second FPU register set 604 is being readied for the next reduction processing cycle;

FIG. 7 demonstrates an exemplary block diagram 800 of a software module that implements the concepts of the present invention;

FIG. 8 illustrates an exemplary hardware/information handling system 800 for incorporating the present invention therein; and

FIG. 9 illustrates a machine-readable medium 900 (e.g., storage medium) for storing steps of a program of a method according to the present invention.

### DETAILED DESCRIPTION OF AN EXEMPLARY EMBODIMENT OF THE INVENTION

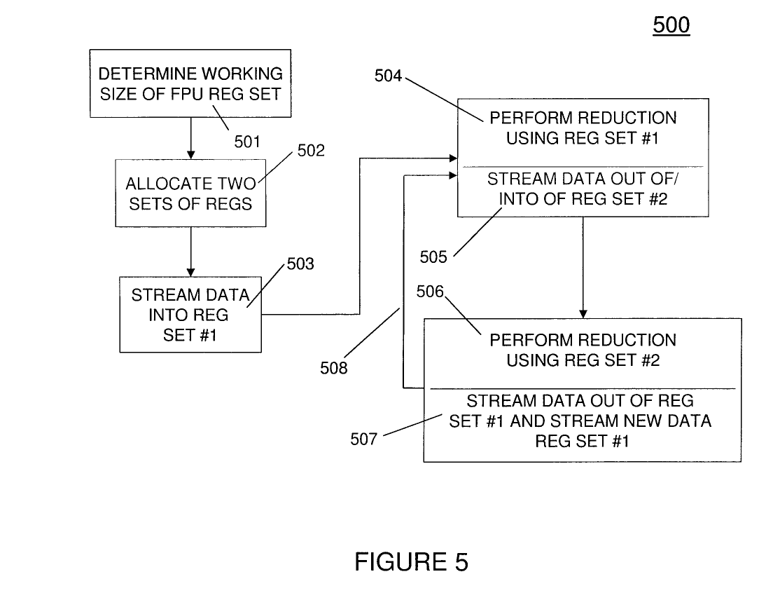

Referring now to the drawings, and more particularly to FIGS. 5-9, an exemplary embodiment of the present invention will now be discussed.

As described briefly above, the present invention involves several concepts. First, the present inventor has recognized that, in order to use the standard hierarchical cache technique more effectively, in conjunction with streaming capabilities, matrix multiplication reduction ultimately results in the FPU, using the FPU register set as the working register space for the reduction processing. As such, and assuming for sake of this explanation that the data in the FPU register set interfaces with memory via the cache hierarchical structure for moving data from memory into the FPU and for moving reduced matrix data back out into memory, the size of the FPU register set used for matrix multiplication reduction can be adapted to virtually eliminate the end-of-reduction overhead of the conventional method.

This result is achieved by reducing the FPU register set size and using two working FPU register sets, such that one set of registers can be used for the current reduction processing and the other set used in a background streaming process for removing the reduced data of the previous reduction cycle and for executing preloading for the next processing cycle, if and as required. Second, efficiency relative to the single-register approach of the conventional method is enhanced by combining this dual-register-set approach with streaming data into or out of one of the two FPU register sets as a background activity, concurrent with the reduction processing occurring in the other register set.

Thus, in contrast to the single largest possible FPU register working space of the conventional wisdom, the present invention teaches to use two sets of FPU registers, one set of which will be used in the current reduction processing, while the other set is concurrently involved in a background data transfer operation of removing reduced data from the previous reduction cycle and any preloading that might be needed for the reduction cycle that will follow the current cycle. The dual-working-space approach permits the reduction processing to continue essentially uninterrupted, thereby virtually eliminating the end-of-reduction overhead and increasing efficiency.

FIG. 5 shows a flowchart 500 of the method of the present invention. In step 501, the working size of the FPU register set is determined. This step would typically be fixed, as based on the design of the FPU, and, as mentioned earlier, the typical FPU register subset used for processing in matrix multiplication reduction is about half the total registers of the FPU.

In step 502, two register sets are allocated to serve as the data exchange between the FPU registers and memory and alternately used for the reduction processing during different reduction cycles. Steps 501 and 502 are steps related to the development of the software to implement the concepts of the present invention, whereas the remaining steps 503-508 describe the memory management steps that would be, for example, embedded in a larger program executing matrix multiplication.

In step 503, data is streamed initially into one of the two register sets so that the reduction processing can be executed using this block of FPU registers by initiating the reduction processing in the FPU in step 504. Concurrent to the reduction processing in the first register set using a first set of matrix data, data is streamed as a background process into the second register set in step 505, in preparation for the next cycle of data reduction, available for a new reduction cycle once the reduction processing is completed on the data of the first data.

In step 506, upon completion of the reduction of the data in the first data block, the background streaming will have been completed, so that the second data block will have been loaded into the second FPU register set for reduction processing and reduction processing can continue on the new data virtually without interruption from the previous cycle. Concurrently, as the next reduction cycle begins, in step 507, the data of the first data block, filled with reduced data from the previous reduction cycle, is streamed back toward memory via the cache hierarchy to be stored either in memory or, possibly somewhere in the cache hierarchy if needed again for additional reduction processing, and new data is streamed back from memory into the first data block in step 508. Again, because this writing of reduced data into memory/higher levels of cache and reading of new data from memory is occurring as a background streaming concurrently to the reduction processing being executed in the FPU, overall efficiency is improved.

In step 508, there is a looping back to continue as long as additional data for reduction exists, alternately using one of the two data blocks for current reduction processing while concurrently using the other of the two data blocks for background streaming to store data that has just been reduced and to load new matrix data for the next cycle of reducing.

Thus, the present invention demonstrates that, in order to be able to use the standard hierarchical technique, whereby one level of the hierarchy uses L1 cache, one needs to be able to execute the reductions on short operands in order to deal with the end-of-reduction overhead. The present invention allows this. Otherwise, one cannot make L1 cache a level of the hierarchy.

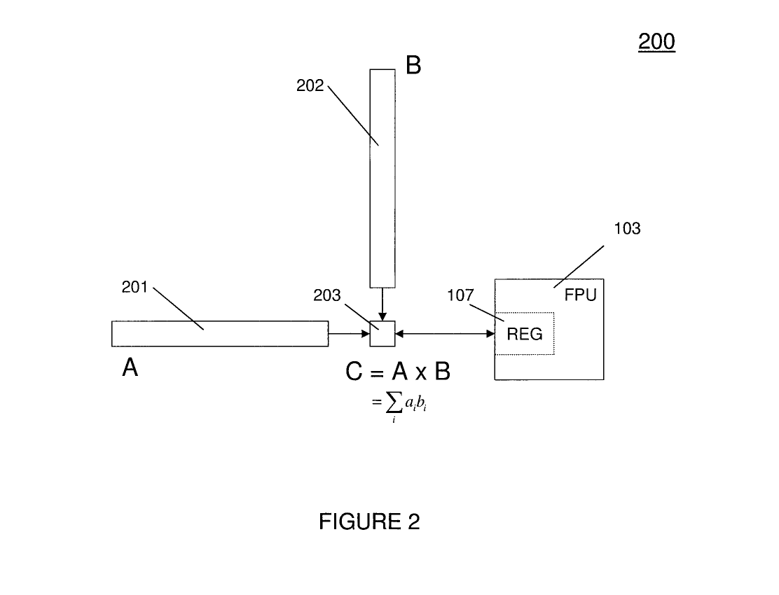

As an aside at this point, it is also noted that to reduce the required operand rate one of the three components of FIG. 2 can often, if not always, be re-used. That is, to start a new operation, there is no need to fetch three entirely new things (two operands and a buffer), since one can re-use either one of the operands, or else the buffer.

It is also noted at this point, that the above description demonstrates how the present invention decouples operand fetch from movement of data in the memory hierarchy. Operands are fetched into the cache at a slow rate in advance, whereby the values fetched are discarded, so that when the operands are needed they can be supplied at a higher rate from the cache. In effect, this technique allows data transfer from memory into cache as a background operation so that processing of data is not interrupted by memory delays.

Matrix multiplication requires n3 operations but only 2*n2 operands, if the C matrix is assumed to be in memory. This requires that operands be fetched at a rate of 2/n operands per operation. Thus, small blocks require a higher rate than large ones.

During the large matrix multiply, operands (e.g., that will be needed in the near future by the basic kernel) are prefetched at a slower rate that is appropriate to the larger matrix size. The result of these fetches is discarded, since the sole purpose is to move the data into fast cache memory.

Most traditional matrix multiplication techniques use blocking schemes, but do not prefetch. Consequently, they still require that the machine's bandwidth exceed the requirement of the basic matrix multiply kernel.

As a consequence, even the most highly optimized algorithms do not exceed 98% of peak performance, even on the largest matrix sizes (matrix multiplication algorithms typically perform better on larger matrices). The present invention allows utilizations in excess of 99%, even on fairly small (100×100) matrix sizes.

There is a penalty in traditional matrix multiplication algorithms when switching from computing one reduction (row of A times column of B) to another. Since the traditional approach is to use a large basic block size, in order to lower the rate, at the end of the reduction the value of the reduction just computed must be saved and the starting value for the new one must be read in. During this data transfer, computation cannot be performed.

One would have to store the starting value in advance to avoid this penalty, but then the basic block size would have to be smaller. Since this penalty is paid only once per reduction, the advantage of a lower operand fetch rate (when using a larger basic block size) outweighs this consideration. Since the invention ensures that operands can be fetched at top speed, there is no reason not to make the basic block size be small enough to store the starting value in advance, thus avoiding this penalty.

Again, traditional algorithms using blocking in the expectation that the operand fetch rate required by the basic block size is low enough to be satisfied (at least most of the time) by the machine's memory hierarchy, and do not address the “switching” penalty. The invention presents such a solution.

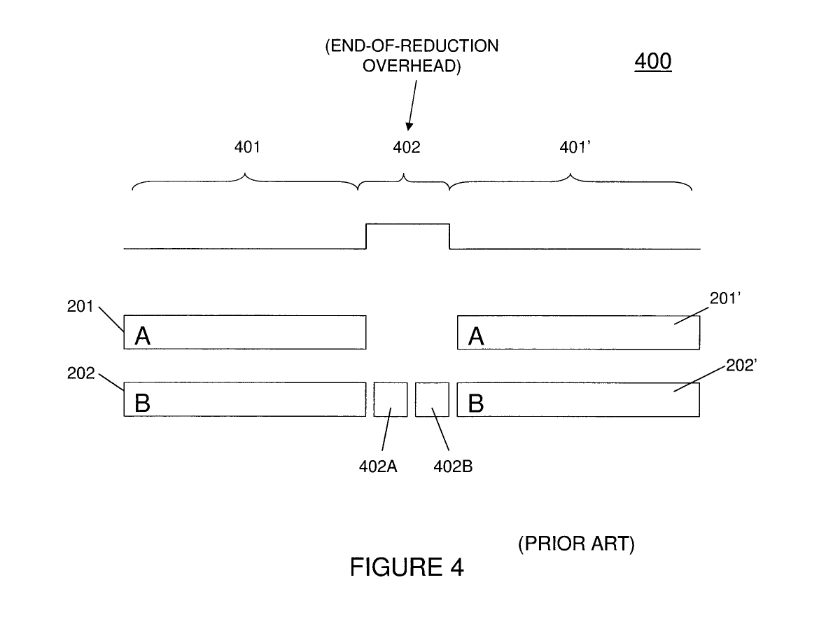

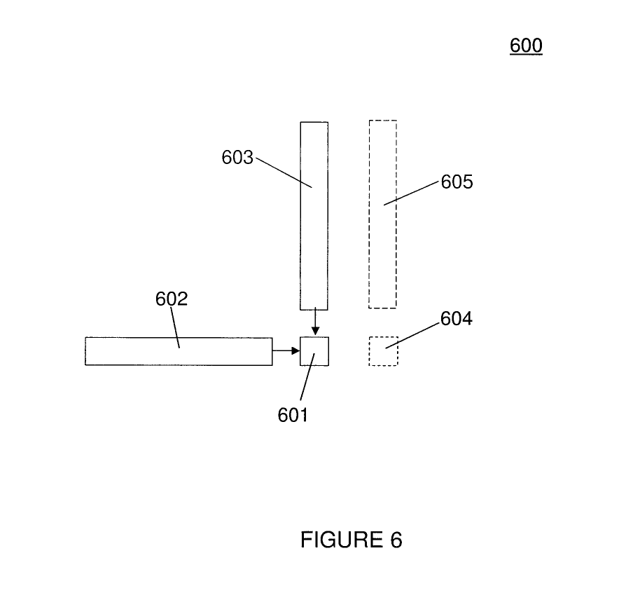

Thus, as shown in FIG. 6, and in contrast to the reduction shown in FIG. 4, the present invention teaches the method 600 of reducing data in one FPU processing cycle in data block 601, using data from rectangular blocks 602, 603 streaming in through the cache hierarchy, while concurrently using the other data block 604 to unload data from the FPU registers of the previous processing cycle and load data for a new cycle as a background streaming operation, followed then by any background streaming for the new rectangular data block 605.

It should be clear from FIGS. 5 and 6 how the flow of the reduction data in accordance with the present invention can be interwoven to virtually eliminate the end-of-reduction overhead 402 of the conventional method by having the two sets of FPU registers continuously swapping roles as having one used for current reduction processing while the other is removing reduction data from the previous reduction processing by streaming the just-completed reduction data from the FPU and, if necessary, pre-loading data for the next cycle of reduction processing.

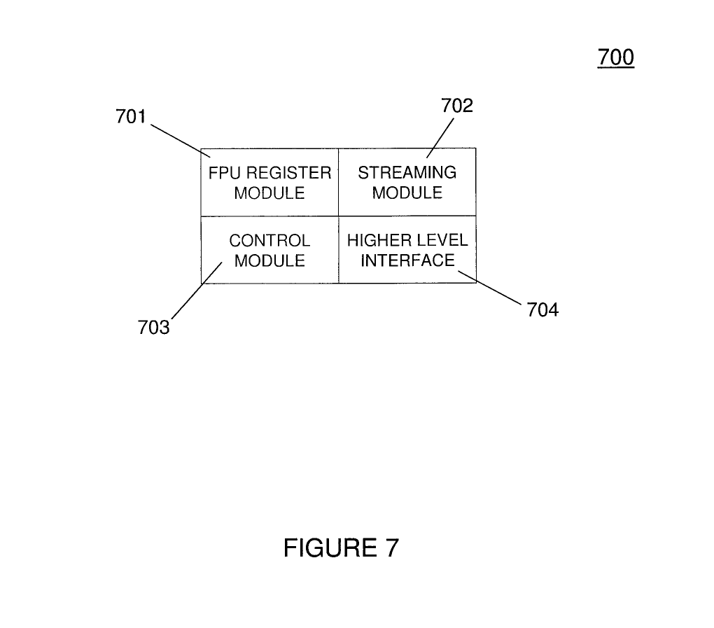

FIG. 7 shows exemplarily a block diagram of one possible software module that implements the concepts of the present invention, for example, as a subroutine within a larger software module invoked for matrix multiplication. FPU Register Module 701 controls the establishment of the two FPU register sets, as well as the loading and unloading of data from and into the FPU. Streaming Module 702 controls the background streaming of data to the FPU register sets and interacts with streaming occurring at the higher levels of cache. Control module 703 is a next higher level that controls the FPU Register Module 701 and Streaming Module 702, and Module 700 interacts with the higher level matrix multiplication module using Interface Module 704.

Exemplary Hardware Implementation

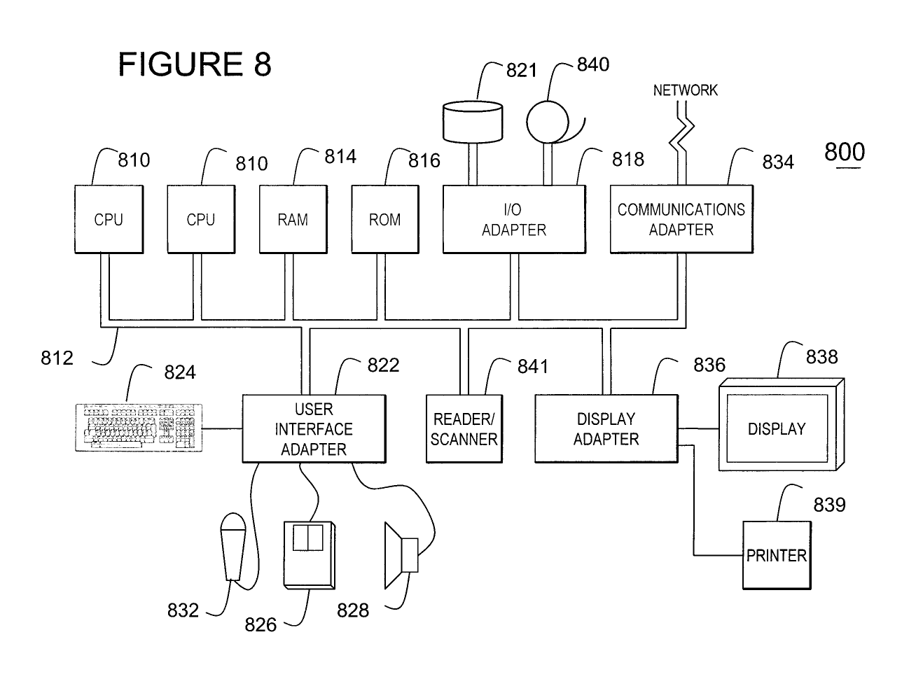

FIG. 8 illustrates a typical hardware configuration of an information handling/computer system 800 in accordance with the invention and which preferably has at least one processor or central processing unit (CPU) 811.

The CPUs 811 are interconnected via a system bus 812 to a random access memory (RAM) 814, read-only memory (ROM) 816, input/output (I/O) adapter 818 (for connecting peripheral devices such as disk units 821 and tape drives 840 to the bus 812), user interface adapter 822 (for connecting a keyboard 824, mouse 826, speaker 828, microphone 832, and/or other user interface device to the bus 812), a communication adapter 834 for connecting an information handling system to a data processing network, the Internet, an Intranet, a personal area network (PAN), etc., and a display adapter 836 for connecting the bus 812 to a display device 838 and/or printer 839 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 811 and hardware above, to perform the method of the invention.

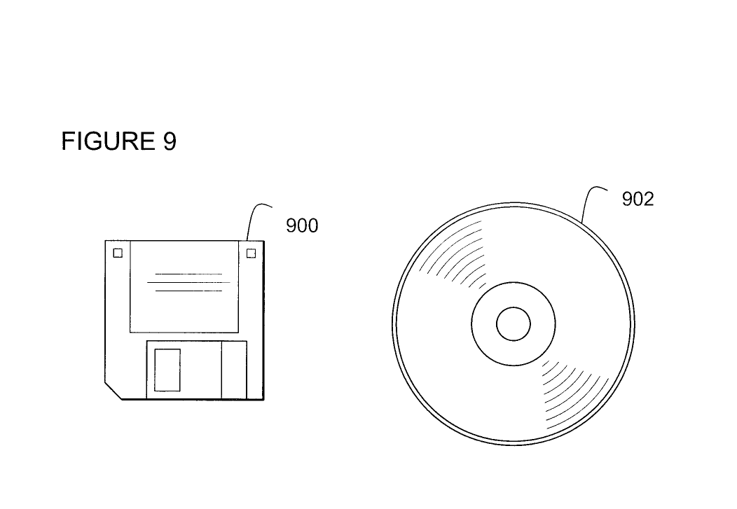

This signal-bearing media may include, for example, a RAM contained within the CPU 811, as represented by the fast-access storage for example. Alternatively, the instructions may be contained in another signal-bearing media, such as a magnetic data storage diskette 900 (FIG. 9), directly or indirectly accessible by the CPU 811.

Whether contained in the diskette 900, the computer/CPU 811, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including storage media suitable for transmission, such as digital and analog and communication links and wireless. In an illustrative embodiment of the invention, the machine-readable instructions may comprise software object code.

In yet another aspect of the present invention, since the present invention can be used to improve efficiency in matrix multiplication in certain limited computer architectures, it further provides an advantage in improvement of services related to endeavors utilizing matrix multiplication on such computers. In this aspect of the present invention, it potentially provides improvement to such services as consulting firms or other business endeavors whose services include determination of a solution involving matrix multiplication and using such determinations as part of a consultation service to other entities.

While the invention has been described in terms of a single preferred embodiment, those skilled in the art will recognize that the invention can be practiced with modification within the spirit and scope of the appended claims. Thus, although matrix processing on an FPU is described, it should be clear that other processing environments might benefit from the method of using alternate blocks of working registers. It should also be clear that, although two sets of registers are used in the exemplary embodiment, there might be processing environments in which more than two sets of working registers in a processing unit would be appropriate.

Further, it is noted that, Applicants' intent is to encompass equivalents of all claim elements, even if amended later during prosecution.

Having thus described our invention, what we claim as new and desire to secure by Letters Patent is as follows:

1. An apparatus, comprising:
a memory to store data for a data processing; and
at least one processing unit having a plurality of registers available for an internal working space for a data processing occurring in said processing unit,
wherein said plurality of registers comprise at least two sets of registers, a first set of said at least two sets interfacing with said processing unit for said data processing in a current processing cycle of said processing and a second set of said at least two sets used for:
removing data from said processing unit of a previous processing cycle to be stored in said memory; and
preloading data into said processing unit from said memory, to be used for a next processing cycle.

2. The apparatus of claim 1, wherein said processing unit performs said removing data and said preloading data as a background operation concurrent with said current processing cycle, said two sets of registers thereby substantially eliminating an end-of-reduction overhead associated with said current processing cycle by said removing data and said preloading data.

3. The apparatus of claim 1, wherein roles of said at least two sets swap as each said processing cycle is completed.

4. The apparatus of claim 1, wherein said processing unit comprises a floating point unit (FPU).

5. The apparatus of claim 1, wherein said processing comprises a matrix multiplication.

6. The apparatus of claim 1, wherein said removing data and said preloading data occurs as a background operation concurrent with said processing in said processor unit.

7. The apparatus of claim 6, wherein background operation comprises a streaming of data.

8. The apparatus of claim 1, wherein said memory comprises a main memory.

9. The apparatus of claim 8, wherein said memory further comprises at least one level of cache memory.

10. The apparatus of claim 1, wherein a size of each set of said at least two sets of registers is a largest size possible to fit into said plurality of registers as two sets of registers plus additional registers needed for said processing.

11. A method of processing data on a digital processing apparatus having a memory to store said data and a processing unit to execute said processing, said processing unit having a plurality of registers available for an internal working space for a data processing occurring in said processing unit, said method comprising:
configuring said plurality of registers to comprise at least two sets of registers, a first set of said at least two sets interfacing with said processing unit for said data processing in a current processing cycle of said processing and a second set of said at least two sets used for:
removing data from said processing unit of a previous processing cycle to be stored in said memory; and
preloading data into said processing unit from said memory, to be used for a next processing cycle.

12. The method of claim 11, further comprising:
exchanging roles of said at least two sets as each said processing cycle is completed.

13. The method of claim 11, wherein said processing unit comprises a floating point unit (FPU) and said processing comprises a matrix multiplication.

14. The method of claim 11, wherein said removing data and said preloading data occurs as a background streaming operation concurrent with said processing in said processor unit.

15. The method of claim 11, wherein said memory comprises a main memory.

16. The method of claim 15, wherein said memory further comprises at least one level of cache memory.

17. The method of claim 16, wherein said processing comprises a matrix multiplication, said method further comprising:
storing blocks of said data in said at least one level of cache memory in accordance with said matrix multiplication processing.

18. The method of claim 11, as embodied in a set of instructions for performing a matrix multiplication processing.

19. A signal-bearing medium tangibly embodying a program of machine-readable instructions executable by a digital processing apparatus to perform a method of processing data on a computer having a memory to store said data and a processing unit to execute said processing, said processing unit having a plurality of registers available for an internal working space for a data processing occurring in said processing unit, said method comprising:
configuring said plurality of registers to comprise at least two sets of registers, a first set of said at least two sets interfacing with said processing unit for said data processing in a current processing cycle of said processing and a second set of said at least two sets used for:
removing data from said processing unit of a previous processing cycle to be stored in said memory; and
preloading data into said processing unit from said memory, to be used for a next processing cycle.

20. The signal-bearing medium of claim 19, comprising one of:
a memory in a digital processing apparatus storing instructions awaiting to be executed;
a memory in a digital processing apparatus storing instructions currently being executed by said digital processing apparatus;
a diskette tangibly embodying a set of instructions, said diskette intended to be inserted into a drive of a digital processing apparatus; and
a memory associated with a server on a network, said server available to send said instructions to another machine attached to said network.
